(19) United States
(12) Patent Application Publication
(10) Pub. No.: US 2016/0218535 A1
(43) Pub. Date: Jul. 28, 2016

(54) RAPID CHARGING DEVICE INCLUDING A PLURALITY OF CHARGING STATIONS

(71) Applicants: Andrew F. Prete, Gilbert, AZ (US); Keith McCord, Florissant, MO (US)

(72) Inventors: Andrew F. Prete, Gilbert, AZ (US); Keith McCord, Florissant, MO (US)

(21) Appl. No.: 14/606,304

(22) Filed: Jan. 27, 2015

(51) Int. Cl. H02J 7/00

(52) U.S. Cl. CPC H02J 7/0044

(57) ABSTRACT

A rapid charging device for charging an internal battery of an electronic device. The rapid charging device includes one or more charging stations. Each charging station includes a charging platform that includes multiple different charging tips. Each of the different charging tips can be used to charge a different type of electronic device. A support cradle in the charging station provides support for the electronic device when the electronic device is being charged. The support cradle is movable relative to the charging platform to position the electronic device above the desired charging tip. The rapid charging device includes internal power supply circuit that regulates the voltage supplied to each of the electronic devices and supplies current above the maximum charging current for the electronic device such that the electronic device can charge at its most rapid rate.

### BACKGROUND

The present disclosure generally relates to a rapid charging device for charging electronic devices, such as smart phones and tablets. More specifically, the present disclosure relates to a rapid charging device that includes a plurality of charging stations that each include a plurality of different charging tips and a power supply circuit that provides a sufficient amount of current for rapid charging electronic devices when the electronic devices are received at each of the charging stations.

Presently, there had been a rapid increase in the use and availability of a wide variety of personal electronic devices, such as smart phones and tablets. Because of the wide variety of functions that can be performed by these electronic devices, the electronic devices are often in heavy use, which requires frequent recharging of the internal battery contained within the electronic device. Most electronic devices include a charging port that can be connected to a charger that includes both a power cord and a transformer that can be plugged into a wall outlet. All of these electronic devices include internal circuitry that allows the electronic device to be charged with 0.5 amps from a USB charging port Larger devices and newer smart phones include a rapid charging feature that allows the internal battery to be charged rapidly charged by drawing up to 3 amps of current. Rapid charging of the electronic device decreases the amount of time that the device needs to be connected to a wall outlet, which is a great benefit to frequent users of the electronic device.

Most electronic devices require that the charging device provides a source of voltage between 5.0 and 5.12 volts for the rapid charging feature. If 5-5.12 volts are not present at the electronic device, the electronic device will default to a trickle charging rate in which the electronic device draws only 0.5 amps for charging. Since may tablets have a relatively large battery, charging the battery of the tablet at a current supply of 0.5 amps takes multiple hours as compared to rapid charging the tablet with between 2.1 and 3.0 amps. Therefore, it is desirable to provide a charger that can supply the electronic device with the required voltage and the maximum current possible to ensure rapid charging.

### SUMMARY

The present disclosure relates to a rapid charging device for charging electronic devices, such as smart phones and tablets. The rapid charging device includes one or more individual charging stations that can charge various different types of electronic devices at a rapid charging rate.

The rapid charging device includes a base that can either rest upon a horizontal support surface or can be mounted to a vertical wall. In one embodiment of the disclosure, the base includes a plurality of charging stations that are each capable of charging the internal battery of an electronic device. The plurality of charging stations are configured such that a plurality of electronic devices can be charged simultaneously.

The rapid charging device includes a power supply circuit contained within the base that operates to provide both a charging current and a charging voltage to the electronic device positioned within the charging station. The internal power supply includes a transformer that converts an AC power source into a constant DC voltage. Each of the charging stations includes its own voltage regulator that operates to supply a constant charging voltage of between 5.0 and 5.12 volts to the electronic device being charged. The voltage regulator assures that the electronic device being charged can be charged at its most rapid charging rate.

Each of the charging stations further includes a charging platform that includes a plurality of different charging tips. The different charging tips included in each of the charging stations allow the rapid charging device to be utilized with various different types of electronic devices that may have different types of charging ports. Each of the charging tips is connected to the internal power supply such that each of the charging tips receives both the charging current and charging voltage needed to charge the electronic device.

Each of the charging stations further includes a support cradle that is movable relative to the charging station and the plurality of charging tips. Each of the support cradles is configured to support the electronic device when the electronic device is connected to one of the charging tips. The support cradle is preferably in a frictional engagement with the base such that the frictional engagement allows the cradle to remain within a desired location relative to the charging tips. Each of the plurality of charging stations includes its own support cradle such that the plurality of charging stations can simultaneously charge different types of electronic devices that may need different types of charging tips.

The internal power supply circuit included within the rapid charging device is designed to provide a supply of charging current to each of the electronic devices such that the electronic device can be charged at a rapid charging rate. In one embodiment of the disclosure, each of the charging stations is supplied with 5 amps of current to ensure that the electronic devices can be charged at their rapid charging rate. The voltage regulator that is included in each of the charging stations regulates the voltage supplied to the electronic device to maintain the electronic device in its rapid charging state.

In one embodiment of the disclosure, the rapid charging device includes four separate charging stations. In an alternate embodiment, the rapid charging device includes two charging stations, in yet another contemplated embodiment, the rapid charging device includes only a single charging station. In each embodiment, the rapid charging device includes a charging station that includes a plurality of charging tips, a support cradle and an internal power supply circuit that regulates the voltage supplied to the electronic device being charged.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is a front perspective view of the rapid charging, device of the present disclosure;

FIG. 2 is a top view of the rapid charging device taken along line 2-2 of FIG. 1;

FIG. 3 is a bottom perspective view of the rapid charging device;

FIG. 4 is a partial section view taken along line 4-4 of FIG. 1;

FIG. 5 is a front perspective view illustrating an alternate embodiment of the rapid charging device;

FIG. 6 is a flow chart illustrating the operation of the rapid charging device; and

FIG. 7 is a schematic illustration of the electronic components incorporated within the rapid charging device.

### DETAILED DESCRIPTION

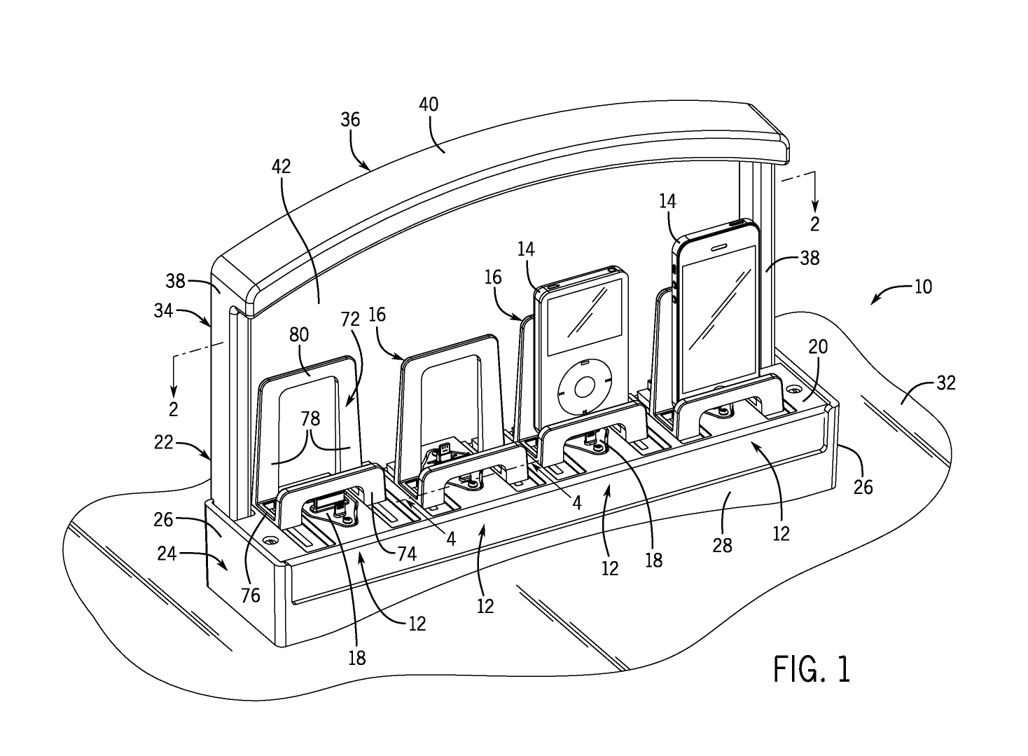

A rapid charging device 10 of a first embodiment of the disclosure is illustrated in FIG. 1. The rapid charging device 10 shown in FIG. 1 includes four separate charging stations 12 that each can be used to recharge an electronic device 14. In the embodiment shown in FIG. 1, one of the electronic devices 14 is an iPhone while the second electronic device is an iPod. As will be described in greater detail below, the rapid charging device 10 of the present disclosure is configured to charge a plurality of electronic devices simultaneously, where the electronic devices can be one of a wide variety of currently available and to be available devices. It is contemplated that the rapid charging device 10 will be able to charge smart phones from various manufacturers, tablets, phablets and any other type of electronic device that includes a charging port that can be received on one of the charging tips located at each of the charging stations 12.

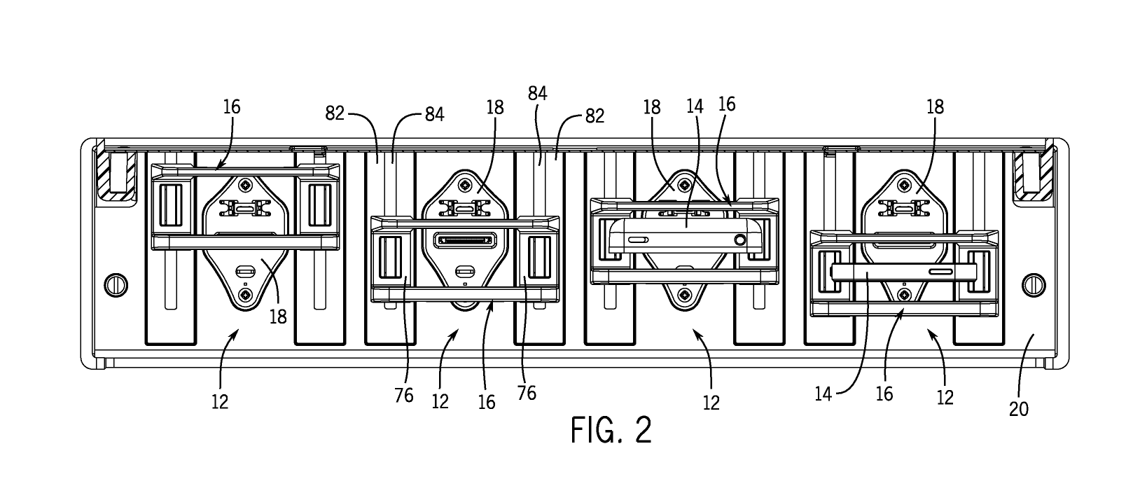

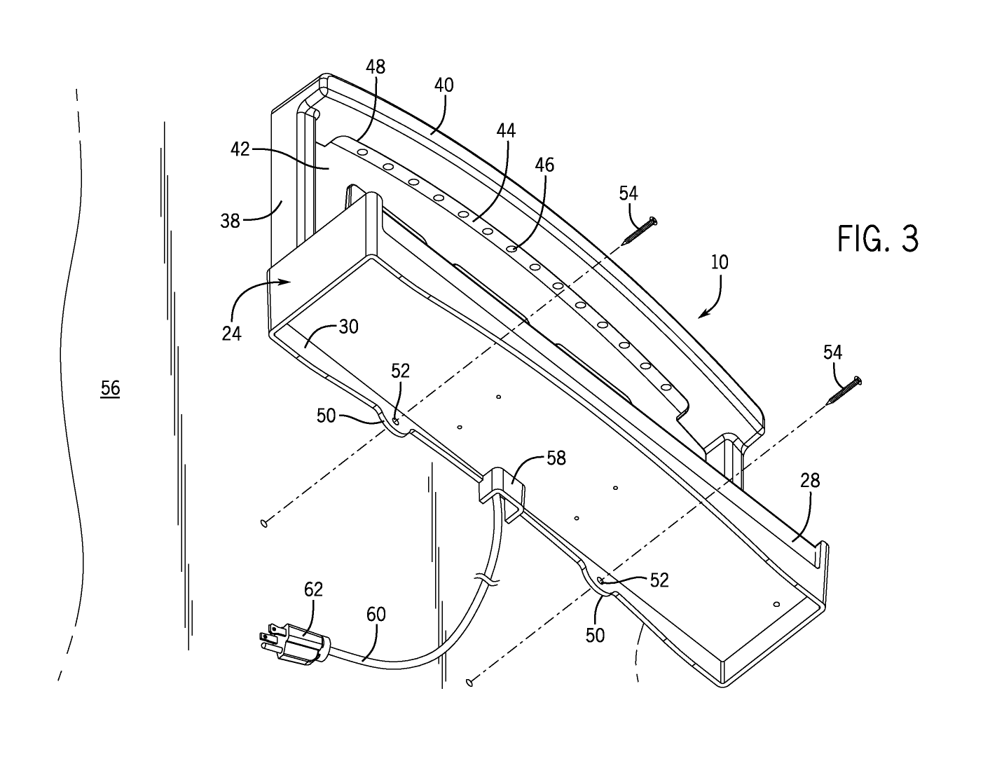

As illustrated in FIG. 1, each of the chanting stations 12 includes a support cradle 16 that is positioned to support a back surface of the electronic device 14 as illustrated. As illustrated in FIG. 2, two of the electronic devices 14 are supported above a charging platform 18 that forms part of each of the charging stations 12. As can be seen in FIG. 1, the four charging stations 12 are identical to each other and are spaced along a generally horizontal support surface 20 of the base unit 22. The base unit 22 includes a lower base 24 that includes a pair of side walls 26, a front wall 28 and a back wall 30 (FIG. 3). The lower base 24 allows the rapid charging device 10 to be supported on a horizontal support surface 32, such as a table, counter, or similar surface.

The base unit 22 further includes an upper display portion 34. The upper display portion 34 includes a back shell 36 that includes a pair of spaced uprights 38 joined to a curve header 40. In the embodiment illustrated, the entire back shell 36, including both of the uprights 38 and the header 40 is an integrally molded plastic element that is designed to provide a visually pleasing appearance for the rapid charger device 10. A back shell 42 is joined to the back surface of both of the uprights 38 and the header 40. The back shell 42 can be designed to include advertising information, branding information or an overall decorative appearance.

Referring now to FIG. 3, in one embodiment of the disclosure, a LED light strip 44 including a plurality of individual LEDs 46 is mounted within the header 40 within a cutout portion 48. The LEDs 46 contained within the LED light strip 44 provide a source of illumination directed downward toward the individual charging stations 12, as can best be understood in FIG. 1. Although the LED light strip 44 is shown in the preferred embodiment, it should be understood that the LED light strip could be eliminated depending upon the particular model of the rapid charger device.

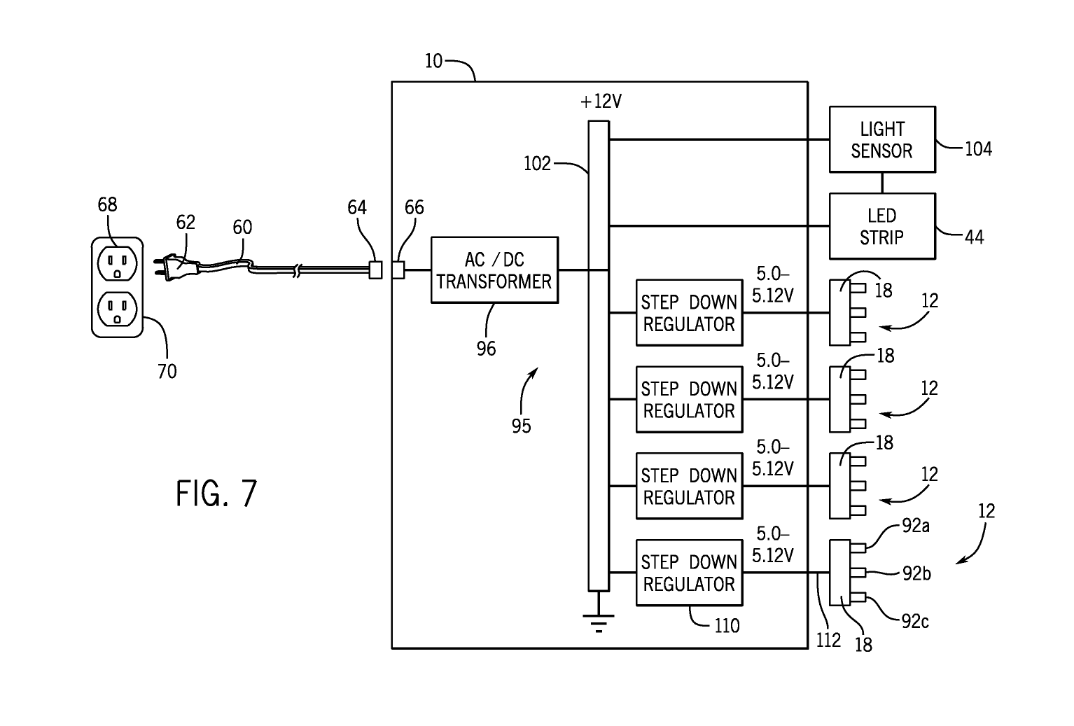

As can be seen in FIG. 3, the back wall 30 of the lower base 24 includes a pair of attachment ears 50 each having a connector opening 52 sized to receive one of the connectors 54 for mounting the entire rapid charger device 10 to a vertical wall 56. The back wall 30 further includes a cord shield 58 that allows an electric cord 60 having a conventional plug 62 on one end and a standard three ear connector 64 on the opposite end (FIG. 7) which allows the entire cord 60 to be easily connected to an internal receptacle 66 of a power supply circuit in the base unit. As illustrated in FIG. 7, the plug 62 can be received in a conventional receptacle 68 on a wall outlet 70. It is contemplated that different cords can be provided with different types of plugs that may be needed for different regions of the world. In this manner, the individual cord 60 can be selected based upon the type of plug 62 needed for the region in which the rapid charger device is being utilized. This allows the entire rapid charger device to be built universally and can be adapted for little cost other than supplying the proper power cord 60 to the end customer.

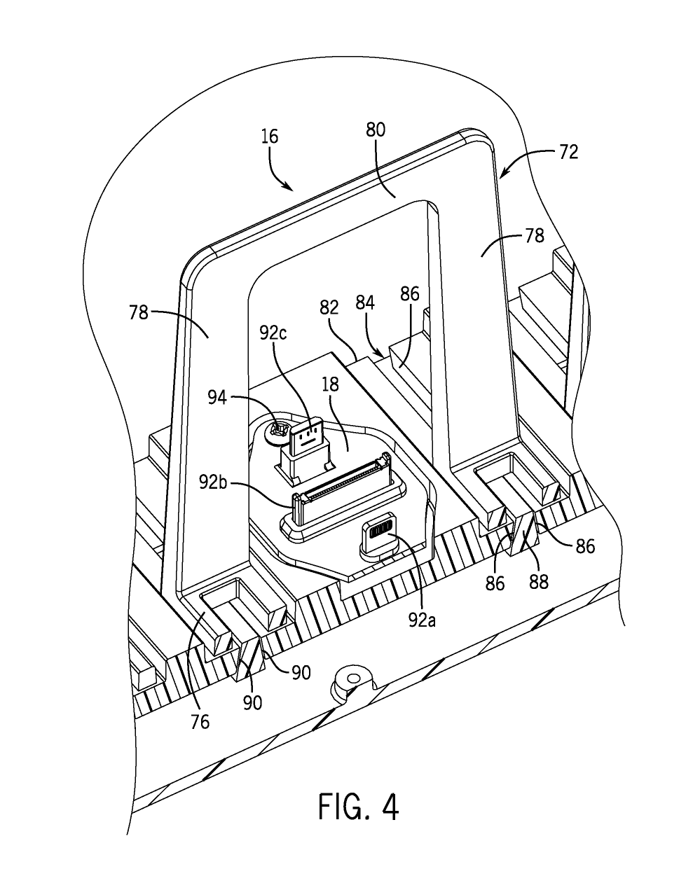

As indicated previously, each of the charging stations 12 includes a support cradle 16, which is shown in both FIGS. 1 and 4. The support cradle 16 includes a back rest 72 spaced from a front wall 74 by a generally horizontal connecting portion 76. The back rest 72 in the embodiment shown in the drawing Figures includes a pair of spaced vertical supports 72 joined to each other by a cross beam 80. Although this particular configuration is illustrated, it should be understood that the back rest 72 could have various other configurations while operating within the scope of the present disclosure.

As illustrated in FIG. 2, the pair of spaced connecting portions 76 of each support cradle 16 is slidably movable within a support track 82 recessed from the surface 20. Each support track 82 includes an open slot 84. As illustrated in FIG. 4, the open slot 84 is defined by a pair of outwardly angled side walls 86. The outwardly angled side walls 86 frictionally engage a slide block 88 that is securely formed and attached to the connecting portion 76 of the support cradle 16.

In the embodiment illustrated, the slide block 88 has a pair of inwardly angled outer walls 90 that frictionally engage the side walls 86 to somewhat restrict the sliding movement of the support cradle 16 within the pair of spaced support tracks 82. Although the dove tail configuration between the slide block 88 and the open slot 84 is illustrated, it should be understood that other types of configurations could be utilized while operating within the scope of the present disclosure.

As illustrated in FIG. 2, each of the support cradles 16 can be moved between one of three desired positions in each of the plurality of charging stations 12. In this manner, the user can selectively position the support cradle 16 above the stationary charging platform 18 of the charging station 12.

Referring now to FIG. 4, each of the charging platforms 18 includes a plurality of different types of charging tips 92. The charging tips 92 are selected to provide a point of charging connection between the largest numbers of different types of electronic devices. In the embodiment shown in FIG. 4, charging tip 92a is an Apple Lightning 8-Pin Charging Tip. Charging tip 92b is an Apple 30-Pin Connector, while charging tip 92c is a micro-USB connector. In the embodiment show in FIG. 4, the three most popular and widely used charging tips 92 are illustrated as being contained on the charging platforms 18. However, different charging tips could be utilized while operating within the scope of the present disclosure.

In the embodiment shown in FIG. 4, the charging platform 18 can be removed through a pair of connectors 94 and replaced with another charging platform 18 having different types of charging tips. The charging tips 92a, 92b and 92c are spaced from each other such that an electronic device can be readily received on the desired charging tip.

In the embodiments shown in the drawing Figures, the charging platform 18 in each of the charging stations 12 includes the charging, tips 92 in the same order. However, it should be understood that the orientation and order of the charging tips 92 could be different for each of the plurality of charging stations 12. Additionally, it is contemplated that the charging platform 18 could include two or even four charging tips depending upon the desired size of the rapid charging device 10.

As can be seen in FIG. 2, two separate electronic devices 14 are being charged in the two rightmost charging stations 12. The rightmost electronic device 14 is received on the outermost charging tip 92a while the second electronic device 14 is received on the middle charging tip 92b. The remaining two charging stations 12 are empty and can receive two additional electronic device devices such that up to four electronic devices can be simultaneously charged.

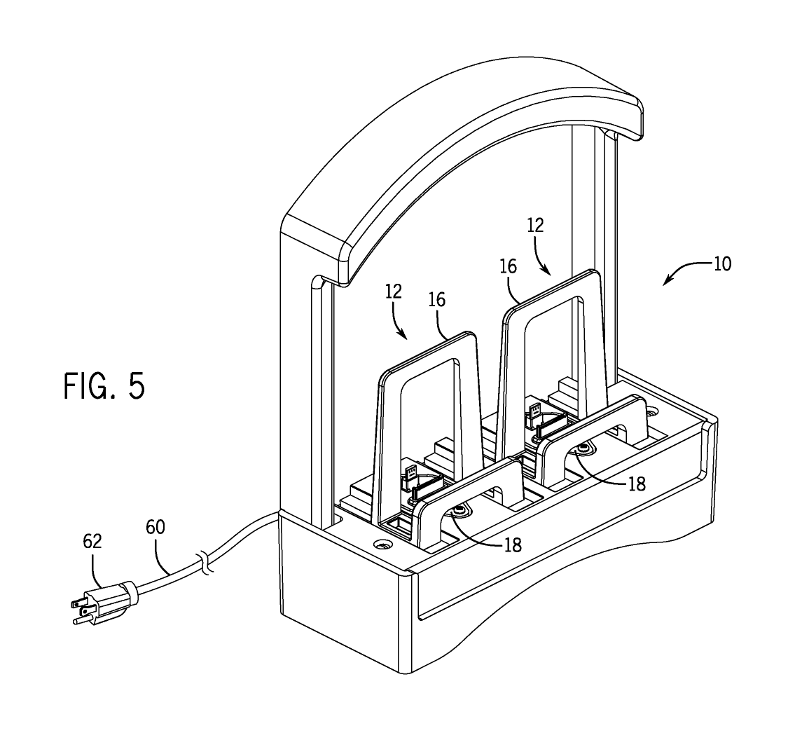

FIG. 5 illustrates a second embodiment of a rapid charging device 10 constructed in accordance with the present disclosure. In the second embodiment shown in FIG. 5, the rapid charging device 10 includes only two charging stations 12 as compared to the four charging stations shown in the embodiment of FIG. 1. Each of the charging stations 12 is configured in an identical manner to the charging stations 12 shown in the embodiment of FIG. 1. Specifically, each of the charging stations 12 includes its own movable support cradle 16 and a plurality of charging tips 92 extending from a charging platform 18. The charging cord 60 connects the internal electronic components of the rapid charging device 10 to a wall outlet in the same manner as previously described.

Although FIG. 1 illustrates an embodiment with four separate charging stations 12 and FIG. 5 illustrates an embodiment with two separate charging stations 12, it should be understood that the rapid charging device 10 could be configured with different numbers of charging stations. It is contemplated that the rapid charging device 10 could be configured to include only a single charging station 12. In such an embodiment, the single charging station 12 would include the same charging platform 18 with multiple charging tips 92.

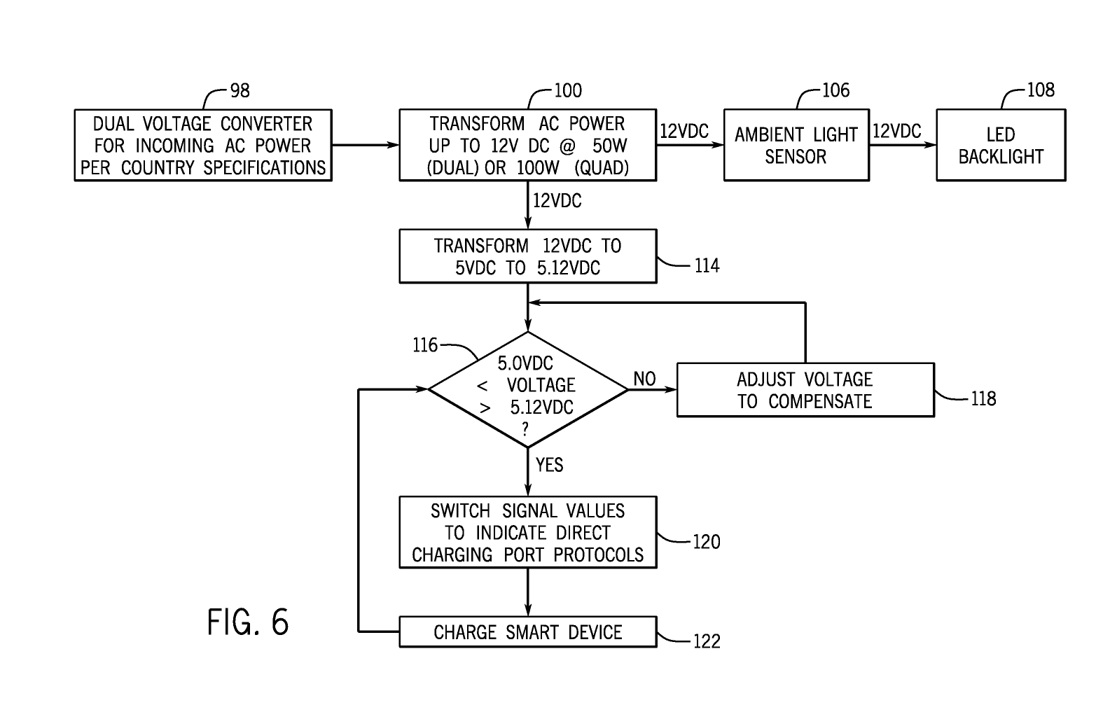

Referring now to FIGS. 6 and 7, the operation of the internal components contained within the rapid charging device 10, will be described. Referring first to FIG. 7, the electric cord 60 includes the three-ear connector 64 that is received within the receptacle 66 formed as part of the rapid charger device 10. The receptacle 66 is connected to an internal power supply circuit 95 that is contained in the base unit. The power supply circuit 95 includes an AC/DC transformer 96. The transformer 96 carries out steps 98 and 100 in FIG. 6. Specifically, the transformer 96 is a dual voltage converter that converts the AC power into a DC output voltage. The transformer 96 is designed to be able to receive the AC power from various different countries and at various different frequencies based upon the individual country. As indicated previously, the power cord 60 shown in FIG. 7 includes a plug 62 that is selected based upon the country in which the rapid charger device 10 will be utilized.

Referring back to FIG. 7, the transformer 96 outputs a 12 volt DC voltage which is available along a 12 volt power rail 102 shown in FIG. 7. The 12 volt power rail 102 allows various different electronic devices and components to receive power and operate as will be described.

As indicated in FIGS. 6 and 7, an ambient light sensor 104 is included as part of the rapid charging device 10, The ambient light sensor 104 is located somewhere along the base unit and senses the amount of light in the area around the rapid charging device. If the ambient light sensor detects a low level of light, as indicated in step 106, the ambient light sensor activates the LED strip 44 to provide LED backlighting, as indicated in step 108. As indicated in FIG. 7, the LED strip 44 is also connected to the power rail 102.

Referring now to FIG. 7, each of the charging platforms 18 included as part of one of the charging stations 12 is schematically illustrated and is connected to the 12 volt power rail 102 through a step down regulator 110. The step down regulator 110 is designed to step down the 12 volts present along the power rail 102 to an output voltage along line 112 that varies between 5.0 and 5.12 volts DC. This transformation is shown in step 114 in FIG. 6. Each of the charging stations 12 includes its own regulator 110 such that the voltage at each of the charging stations is separately controlled and regulated.

As indicated previously, most electronic devices are able to operate in a rapid charging mode when the charging voltage presented to the electronic device falls within the range of 5.0-5.12V DC. If the voltage falls outside of this range, the electronic device may drop out of the rapid charging rate. Thus, each of the step down regulators 110 not only steps down the 12 volts present on the power rail 102, but also continuously monitors the voltage on the line 112 to ensure that the voltage remains in the range of 5.0-5.12 volts.

The operation of the step down regulator 110 is shown in FIG. 6. Initially, the step down regulator determines in step 116 whether the output voltage along line 112 is in the range of 5.0-5.12V DC. If the voltage is not within this range, the regulator proceeds to step 11$ and adjusts the voltage to compensate for the variation. This process continues until the regulator determines in step 116 that the voltage is within the desired range of 5.0-5.12 volts. When the voltage is within this range, the system determines in step 120 what type of device is being charged by the rapid charging device.

Presently, two different types of charging protocols are used in many different electronic devices. The first type of protocol is referred to as the Dedicating Charging Port (DCP) while the second type of protocol is referred to as the Charging Downstream Port (CDP). Based upon the detected type of device, the system switches signal values to indicate the proper protocol in step 120. Once the proper protocol has been identified and configured, the system moves to step 122 and begins to charge the electronic device through the selected charging tip. As illustrated in FIG. 7, each of the charging platforms 18 includes three separate charging tips 92a, 92b and 92c.

In the embodiment shown in FIG. 7, the AC/DC transformer is designed to provide 100 watts of power to the combination of the four charging station in the embodiment shown in FIG. 1. When the transformer 96 is utilized within the two charging station embodiment shown in FIG. 5, the transformer 96 is selected to have a maximum output of 50 watts. Since the transformer 96 in the embodiment of FIG. 1 can supply 100 watts of power and the voltage available to each of the charging platforms 18 is strictly regulated between 5.0 and 5.12 volts, the transformer 96 is able to supply 5 amps of current to each of the charging platforms 18. Thus, if an electronic device is received on each of the four charging platforms 18, the four electronic devices can each simultaneously receive S amps of current from the transformer 96. At the same time, the regulator 110 maintains the output voltage supplied to the device to the desired range between 5.0-5.12 volts DC such that the device remains in its rapid charging mode.

Newly available smart phones and tablets include internal operating circuits that limit the amount of current supplied to the battery for charging. These devices internally limit the current to approximately 2.1 amps to prevent overheating of the internal battery. Recently released smart phones include rapid charging modes in which the smart phone allows the battery to be initially charged utilizing 3.0 amps for approximately half of the charging cycle. Once half of the charging, cycle is complete, the internal circuitry reduces the amount of current that is provided to the battery for charging. As can be understood, the rapid charging device 10, and specifically the transformer 96, is able to provide 5 amps of current to each device being charged, which will support the most aggressive charging phases in currently available electronic devices. The transformer 96 of the present disclosure provides enough current that the electronic device can utilize the internal circuitry to limit the current supply to charge the internal battery.

This written description uses examples to disclose the invention, including the best mode, and also to enable any person skilled in the an to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A rapid charging device for charging an internal battery in each of a plurality of electronic devices, comprising:
a plurality of charging stations each capable of charging one of the electronic devices such that the plurality of electronic devices can be charged simultaneously;
a plurality of different charging tips included in each of the charging stations, wherein each of the charging tips is connected to an internal power supply circuit that provides a source of charging current; and
a support cradle included in each of the charging stations, wherein the support cradle is moveable relative to the plurality of charging tips and configured to support one of the electronic devices when the electronic device is connected to one of the charging tips.

2. The rapid charging device of claim 1 further comprising a base that at least partially defines each of the plurality of charging stations, wherein each of the support cradles is moveable within the base.

3. The rapid charging device of claim 2 wherein each of the support cradles frictionally engages the base to hold the support cradle in a desired position relative to the plurality of charging tips within the charging station.

4. The rapid charging device of claim 1 wherein the plurality of charging tips includes at least three charging tips.

5. The rapid charging device of claim 1 wherein the power supply circuit includes a transformer contained in the rapid charging device.

6. The rapid charging device of claim 1 wherein the plurality of charging stations includes two charging stations.

7. The rapid charging device of claim 1 wherein the plurality of charging stations includes four charging stations.

8. The rapid charging device of claim 1 wherein the power supply circuit provides at least 5 amps to each of the charging stations.

9. The rapid charging device of claim 1 wherein the power supply circuit includes a plurality of step down regulators that are each associated with one of the charging stations, wherein each of the step down regulators regulates the supply of voltage to each of the charging tips within the charging station within a range of 5.0-5.12V DC.

10. A rapid charging device for charging an internal, battery of an electronic device, comprising:
a charging station;
a plurality of charging tips included in the charging station, wherein each of the plurality of charging tips has a different configuration; and
a support cradle included in the charging station and moveable relative to the plurality of charging amps, wherein the support cradle is selectively moveable to align the electronic device with one of the charging tips.

11. The rapid charging device of claim 10 further comprising a base that at least partially defines the charging station, wherein the support cradle is moveable within the base.

12. The rapid charging device, of claim 11 wherein the support cradle frictionally engages the base to hold the support cradle in a desired position relative to the plurality of charging tips within the charging station.

13. The rapid charging device of claim 10 wherein the plurality of charging tips includes at least three charging tips.

14. The rapid charging device of claim 11 wherein a source of charging current within the base provides at least five amps to the charging tips of the charging station.

15. The rapid charging device of claim 14 further comprising a step down regulator that regulates the supply of voltage to the charging tips within a range of 5.0-5.12V DC.

16. A rapid charging device for simultaneously charging an internal battery of a plurality of electronic devices, comprising:
a plurality of charging stations each configured to receive one of the electronic devices;
a plurality of different charging tips included in each of the charging, stations;
a power supply circuit contained within the rapid charging device, wherein the power supply circuit supplies a regulated voltage and a charging current to each of the charging, tips; and
a support cradle included in each of the charging stations, wherein the support cradle is movable relative to the plurality of charging tips and is configured to support the electronic device when the electronic device is connected to one of the charging tips.

17. The rapid charging device of claim 16 wherein the power supply provides at least 5 amps to each of the charging tips.

18. The rapid charging device of claim 16 wherein each of the charging stations includes at least three charging tips.

19. The rapid charging device of claim 16 wherein the power supply circuit includes a plurality of step down regulators that are each associated with one of the charging stations to regulate the supply of voltage to each of the charging tips within a range of 5.0-5.12V DC.

20. The rapid charging device of claim 16 wherein the support cradle frictionally engages a base of the rapid charging device to hold the support cradle in a desired position.
